(19) United States
(12) Patent Application Publication
(10) Pub. No.: US 2021/0349480 A1
(43) Pub. Date: Nov. 11, 2021

(54) OPERABLE WALL ASSEMBLY CONTROL USING VOICE COMMANDS

(71) Applicant: Hufcor, Inc., Janesville, WI (US)

(72) Inventors: Kurt E. Rebarchek, Janesville, WI (US); Konrad T. Kroczynski, Fitchburg, WI (US)

(21) Appl. No.: 16/869,823

(22) Filed: May 8, 2020

(51) Int. Cl. G05D 3/20; E06B 9/24; E04B 2/74; E04B 2/82

(52) U.S. Cl. CPC G05D 3/20; E06B 9/24; G01S 17/93; E04B 2/827; E06B 2009/2417; E04B 2/7401

(57) ABSTRACT

Systems and methods for controlling an operable wall configured to move between a deployed condition and a stacked condition. The method includes receiving a voice command from a user via a microphone and initiating a wall movement of the operable wall based on the received voice command. In response to detecting an object with at least one sensor of the plurality of sensors, the wall movement is stopped and an alert is provided to the user that the wall movement has stopped. When the detected object is no longer detected by the at least one sensor, the wall movement is automatically resumed.

### BACKGROUND

The present invention relates to systems and methods for controlling an operable wall assembly using voice commands.

Wall partitions are used to create mobile barriers between different portions of open space. For example, in a classroom setting, a wall partition can be used to divide a room into two distinct sections.

Current wall partition systems require a user to manually extend and retract the wall partition or control the wall partition via an actuator, such as a switch or button. However, the wall partition is heavy and may potentially harm people or damage objects in the path of the movement of the wall. Because the user is controlling the wall partition with an actuator, the user may not be able to detect people or objects in the path of movement of the wall. Therefore, a system is needed to both remove the need for a user to control a wall partition with an actuator and to ensure the safety of people and objects within the movement path of the wall partition.

### SUMMARY

In one embodiment, the invention provides a system for controlling an operable wall configured to move between a deployed condition and a stacked condition. The system includes a microphone, a plurality of sensors, and an electronic processor. The electronic processor is configured to receive a voice command from a user via the microphone; initiate a wall movement of the operable wall based on the received voice command; and in response to detecting an object with at least one sensor of the plurality of sensors, stop the wall movement; provide an alert to the user that the wall movement has stopped; and when the detected object is no longer detected by the at least one sensor, automatically resuming the wall movement.

In another embodiment the invention provides a method of method for controlling an operable wall configured to move between a deployed condition and a stacked condition. The method includes receiving, with an electronic processor, a voice command from a user via a microphone; initiating, with the electronic processor, a wall movement of the operable wall based on the received voice command; and in response to detecting an object with at least one sensor of the plurality of sensors, stopping, with the electronic processor, the wall movement; providing, with the electronic processor, an alert to the user that the wall movement has stopped; and when the detected object is no longer detected by the at least one sensor, automatically resuming, with the electronic processor, the wall movement.

Other aspects of the invention will become apparent by consideration of the detailed description and accompanying drawings.

### BRIEF DESCRIPTION OF THE DRAWINGS

FIG. 1 is a perspective view of an operable wall assembly embodying the present invention and showing the wall panels deployed.

FIG. 2 is a perspective view of the operable wall assembly with the wall panels stowed.

FIG. 3 is a top view of the operable wall assembly showing the initial movement of the stack panel being stowed.

FIG. 4 is a top view of the operable wall assembly showing wall panels being stowed.

FIG. 5 is a top view of the operable wall assembly in the fully stowed condition.

FIG. 6 is a block diagram illustrating a control system for the operable wall assembly.

FIG. 7 is a graphical representation of a user interface for operating the control system.

FIG. 8 is a flow chart of a method for controlling the operable wall assembly.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

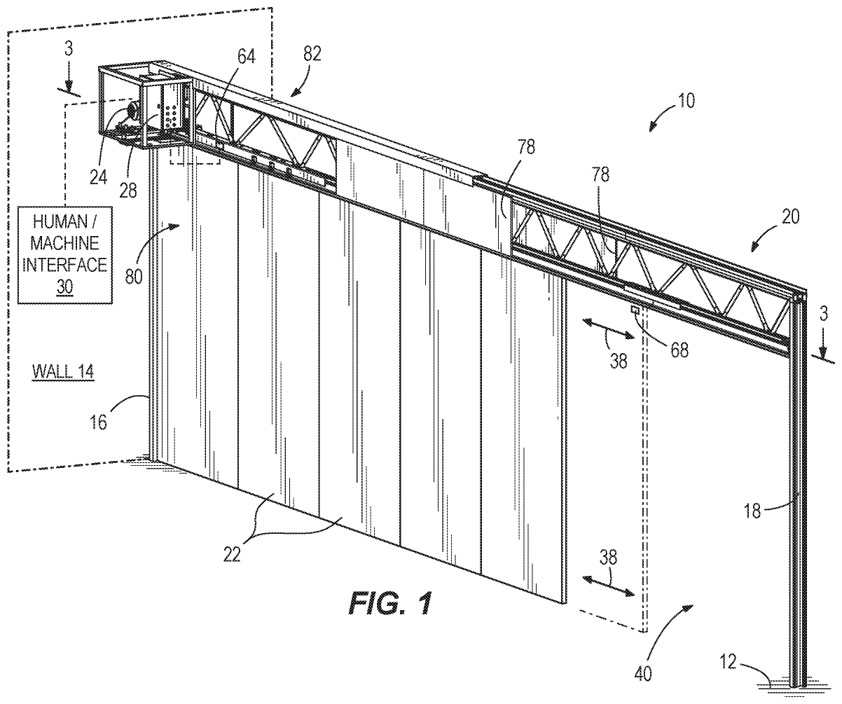

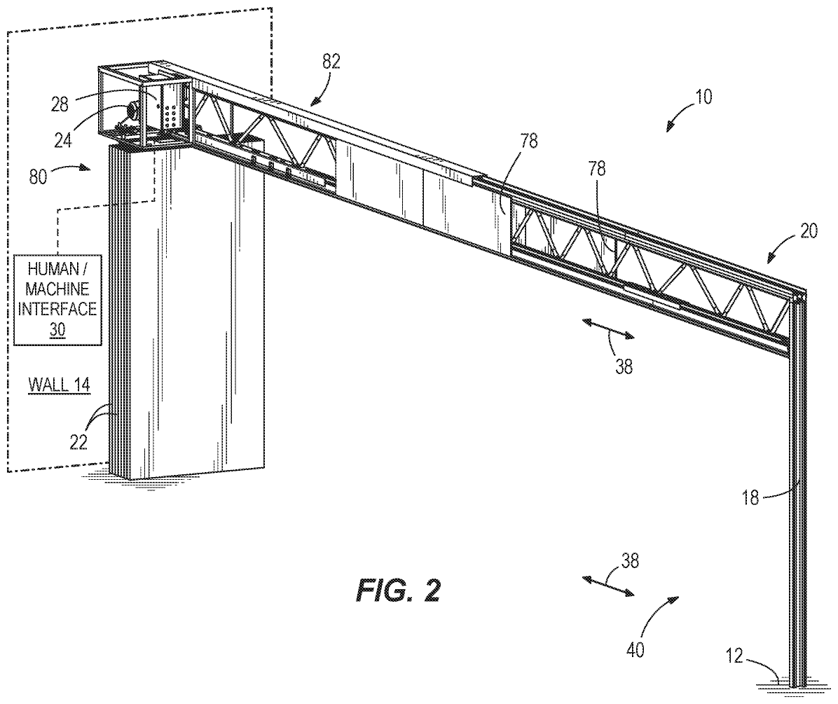

FIGS. 1 and 2 illustrate an operable wall assembly 10 for use in a building having a floor 12 and a stationary wall 14. As will be discussed in more detail below, the operable wall assembly 10 is configurable in or movable between a deployed condition (FIG. 1) and a stacked condition (FIG. 2). The present invention is generally concerned with moving the operable wall assembly 10 between the deployed and stacked conditions in response to one or more user inputs, such as a voice command, from a user as opposed to manually extending the wall.

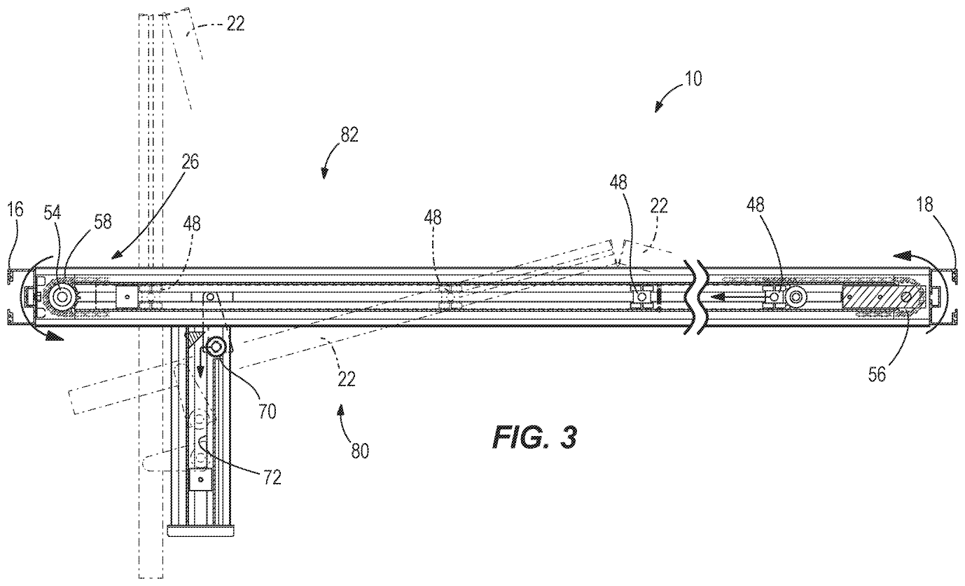

The operable wall assembly 10 includes a first end support 16, a second end support 18, a top support assembly 20, a plurality of wall panels 22, a prime mover 24, a drive system 26 (FIG. 3), a control system 28, and a human-machine interface (“HMI”) 30. A space 40 is bounded by the first and second end supports 16, 18, the top support assembly 20, and the floor 12. The plurality of wall panels 22 are suspended from the top support assembly 20 and are movable in the directions indicated with arrows 38 between the deployed condition (FIG. 1) and the stacked condition (FIG. 2). The vertical edge of each panel 22 that is closest to the second end support 18 will be referred to as the “leading edge” of the panel 22 the vertical edge closest to the first end support 16 will be referred to as the “trailing edge.” The leading edge of each panel 22 is pivotally connected to the trailing edge of the adjacent panel 22 so that the panels zig-zag when they are moved between the stacked and deployed conditions (see FIGS. 3-5). The panel 22 closest to the second end support 18 will be referred to as the “lead panel” and the panel 22 closest to the first end support 16 will be referred to as the “stack panel.” The wall panels 22 close the space 40 when the operable wall assembly 10 is in the deployed condition and do not close the space 40 (i.e., at least partially open the space 40) when the operable wall assembly 10 is in the stacked condition.

In the illustrated embodiment, the prime mover 24 is an electric motor. The term “prime mover” is intended to be interpreted broadly to include any device providing a motive force to move the panels between the deployed and stacked conditions. The prime mover 24 may include an energy storage component, such as a spring. The prime mover 24 operates at the instruction of the control system 28 in a stacking mode (in which the prime mover 24 moves the panels 22 toward the stacked condition) and a deploying mode (in which the prime mover 24 moves the panels 22 toward the deployed condition).

With reference to FIGS. 3-5, each of the panels 22 is connected to the top support assembly 20 by a respective panel carrier 48. The panel carriers 48 are permitted to slide along a top of the respective panel 22 to facilitate pivoting of the panels 22 between a stowed orientation and a deployed orientation. The panel carriers 48 are each permitted to slide between an end of the respective panel 22 and a stop 50 positioned near a middle of the respective panel 22.

As described in greater detail in U.S. Pat. No. 10,415,288, the contents of which are herein incorporated by reference, the drive system 26 includes a drive sprocket 54, a return sprocket 56, and a chain 58. The drive system 26 is drivingly connected to the prime mover 24 by a transmission or other suitable driving configuration. The panel carrier 48 that is connected to the lead panel 22 is connected to one side of the chain 58 for movement with the chain 58. When the prime mover 24 is operating in the stacking mode, the drive sprocket 54 is rotated in a first direction to rotate the chain 58 about the drive sprocket 54 and the return sprocket 56 to thereby move the panels 22 toward the first end support 16. When the prime mover 24 is operating in the deploying mode, the drive sprocket 54 is rotated in a second direction to rotate the chain 58 about the drive sprocket 54 and the return sprocket 56 to thereby move the panels 22 toward the second end support 18. The chain 58 may be referred to more generically as a “force transmitting member” and or a “flexible force transmitting member.” In other embodiments of the invention, the chain 58 can be replaced with other force transmitting members or flexible force transmitting members such as a belt, strap, or cable.

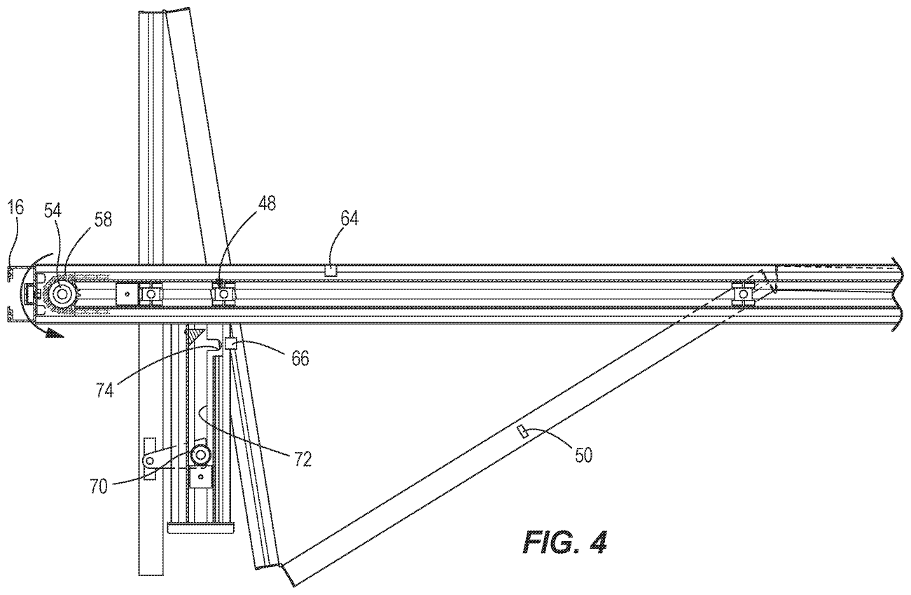

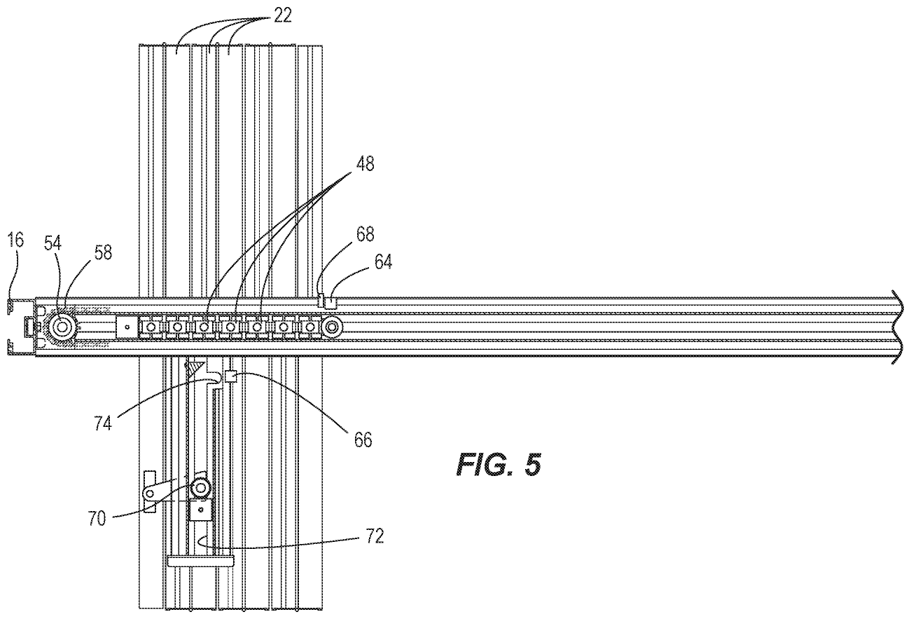

The control system 28 monitors the status of a stack limit switch 64 (FIGS. 1, 4 and 5) and a deploy limit switch 66 (FIGS. 4 and 5) to control the prime mover 24 operating in respective stacking and deploying modes. The control system 28 includes a controller which is in communication with the switches 64, 66 via wired or wireless connections. The control system 28 monitors the stack limit switch 64 while operating the prime mover 24 in stacking mode and monitors the deploy limit switch 66 while operating the prime mover 24 in deploying mode.

Referring to FIGS. 1, 4 and 5, the stack limit switch 64 is mounted to the top support assembly 20 may be, for example, a magnetic switch. As illustrated in FIGS. 1 and 5, the lead panel 22 or lead carrier 48 includes a complimentary component 68 (e.g., a magnet) that is recognized by the stack limit switch 64. The stack limit switch 64 is positioned on the top support assembly 20 such that it recognizes the complimentary component 68 when the lead panel 22 stacked. Upon recognizing the complimentary component 68, the stack limit switch 64 sends a signal to the control system 28 and the control system 28 turns off the prime mover 24. In other embodiments, the stack limit switch 64 and complimentary component 68 may be a contact switch or any other suitable switch.

Referring to FIGS. 3-5, a diverter roller 70 moves along a track 72 while the panels 22 are stowed and deployed. The track 72 includes a notch 74 at one end of the track 72. While the panels 22 are stowed or partially deployed, the diverter roller 70 is positioned on the end of the track 72 spaced from the deploy limit switch 66 and the notch 74 (see FIGS. 4 and 5). While the panels 22 are fully deployed, the diverter roller 70 moves to the other end of the track 72 and into the notch 74 to thereby engage the deploy limit switch 66 (see FIG. 3). Upon being engaged, the deploy limit switch 66 sends a signal to the control system 28 to turn off the prime mover 24. In other embodiments, the deploy limit switch 66 may be a magnetic switch or other suitable switch.

The HMI 30 is an interface that allows a user to control the operable wall assembly 10. In some embodiments, the HMI 30 is a wall-mounted touch screen that receives input from the user to, among other things, extend and retract the operable wall assembly 10. In other embodiments, the HMI 30 is a mobile device, such as a smartphone, tablet, or other mobile device that includes a touch screen for receiving input from the user.

A noise-reducing panel 78 can be connected to the top support assembly 20. In some embodiments, the noise-reducing panel 78 can be configured to substantially match the panels 22 in color and material. In some embodiments, the panels 22 are solid and fully opaque. In other embodiments, the panels 22 include one or more glass windows. In some embodiments, the panels 22 are glass panels. In some embodiment, the panels are glass panels can be configured to change between transparent and opaque. In embodiments that include glass panels, the noise-reducing panel 78 can be a different material than the panels 22.

The top support assembly 20 includes a first side 80 and second oppositely-facing side 82. As illustrated, the prime mover 24 and the control system 28 are both mounted to the first side 80 of the top support assembly 20, and the second side 82 has a finished and clean appearance. The terms first side 80 and second side 82 can be applied for reference to any components of the operable wall assembly 10 and the operable wall assembly 10 generally. This may be useful in retail or other settings involving customers or clients, in that the second side 82 can face out toward the customers or clients (i.e., a “customer-facing” or “client-facing” side or storefront) while the prime mover 24 and control system 28 are hidden from view. In other constructions, the prime mover 24 and control system 28 may be supported elsewhere and not be carried by the top support assembly 20 (i.e., they may not be “supported portions”). For example, the prime mover 24 and/or control system 28 may be independently mounted to the structure of the building or room.

In some embodiments, one or more of the panels 22 includes an electrical outlet and/or one or more connections for a computer, an audio/visual connection, USB connection or other suitable communication connection. The panels 22 each include the necessary wires/cords to facility such connections. The wires/cords can be positioned in conduit and are in electrical communication with a power or communication supply of the building. A connectivity check is run by the control system 28 with a relatively low voltage prior to supplying the panels 22 with the required amount of power for operating the operable wall assembly 10 and operating any other electrical components, such as the computer, attached to the panels 22. The connectivity check also

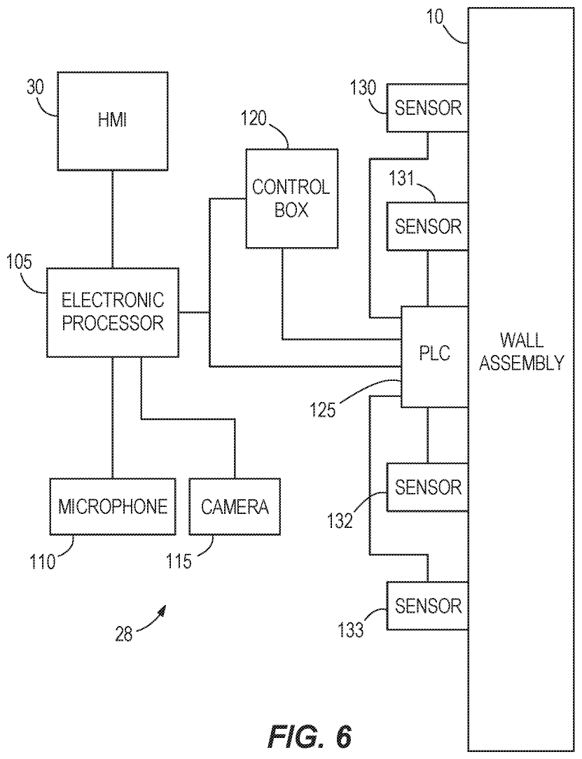

FIG. 6 illustrates the control system 28 for the operable wall assembly 10. The control system 28 includes an electronic processor 105, a microphone 110, a camera 115, a control box 120, the HMI 30, a programmable logic controller (“PLC”) 125, and a plurality of sensors 130-133.

The electronic processor 105 is configured to, among other things, execute instructions stored in a memory to perform the methods and functions described herein. In some embodiments, the electronic processor 105 is a microprocessor, application-specific integrated circuit (“ASIC”), or other control circuit. It is to be understood that one or more processors may be used in the control system 28 to perform the functions of electronic processor 105.

The microphone 110 receives audio data, such as voice commands, and then transmits the audio data via a communicative connection, such as wireless or wired connection, to the electronic processor 105. For example, a user of the control system 28 may speak a command phrase, such as “Extend Wall,” which is sensed by the microphone 110 and then provided to the electronic processor 105.

The camera 115 is coupled to one of the panels 22, such as on a leading edge of a leading panel of the panels 22. The camera 115 provides video data of an area in front of the leading edge of the panels 22 and provides the video data to the electronic processor 105 over a communicative connection, such as a wireless or wired connection.

The control box 120 is a variable frequency drive controlling the prime mover 24 and also provides power to the control system 28. The control box 120 is configured to receive commands from the electronic processor 105 over a communicative connection, such as a wireless or wired connection, and, in turn, control the prime mover 24 based on the received commands. For example, a motor speed of the prime mover 24 is controlled by the control box 120.

The PLC 125 is a programmable logic controller configured to execute ladder logic commands for the panels 22 of the operable wall assembly 10. For example, after the electronic processor 105 receives a voice command from the microphone 110, the electronic processor 105 generates a command for the PLC 125 and sends the command over a communicative connection, such as a wireless or wired connection, to the PLC 125. The PLC 125 in turn executes the command on the panels 22 of the operable wall assembly 10, such as executing ladder logic to extend the panels 22.

The plurality of sensors 130-133 are various sensors used for object detection in a movement path of the operable wall assembly 10. In some embodiments, the plurality of sensors 130-133 are located, like the camera 115, on the leading edge of the operable wall assembly 10. In other embodiments, the plurality of sensors 130-133 are located at various places on the panels 22. The plurality of sensors 130-133 may include, among other types of sensors, a LIDAR sensor, a camera, a lead bump detection sensor, an ultrasonic sensor, a PIR sensor, and a microwave sensor. The plurality of sensors 130-133 provide sensor data of their respective sensor type to the PLC 125 over a communicative connection, such as a wireless or wired connection, which then executes ladder logic based on the sensor data. For example, and as described in more detail below, one of the plurality of sensors 130-133 may detect an object and, based on the provided data, the PLC 125 may execute ladder logic to stop a wall movement.

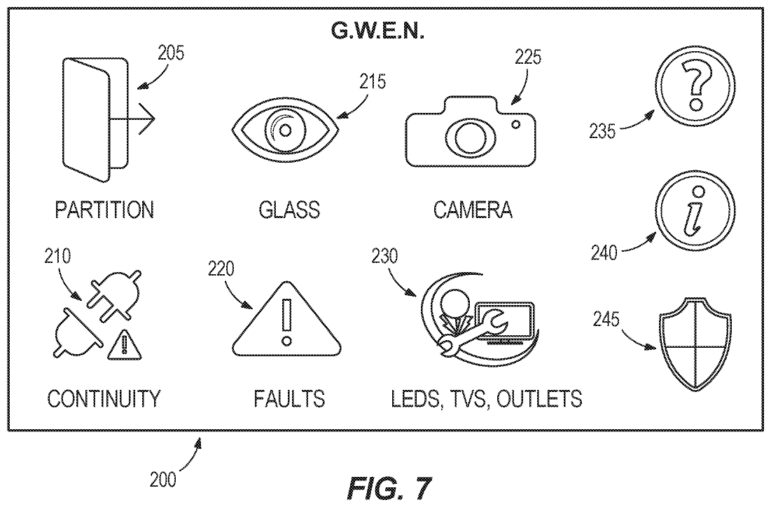

The HMI 30 displays, on the touch screen, a graphical user interface (“GUI”), such as GUI 200 illustrated in FIG. 7. For example, the GUI 200 is displayed on the touch screen of a mobile device acting as the HMI 30. The GUI includes a partition widget 205, continuity widget 210, a glass widget 215, a faults widget 220, a camera widget 225, a devices widget 230, a help widget 235, an about widget 240, and an administrator widget 245.

The partition widget 205, when selected by the user of the HMI 30, provides a list of partitions that are available to control. Each of the partitions correspond to an operable wall assembly, such as the operable wall assembly 10. In some embodiments, the list of partitions also provides a status for each operable wall assembly, such as “extended” or “retracted.” In further embodiments, the user of the HMI 30 may also provide commands to the various operable wall assemblies by selecting commands within the list of partitions, such as “extend” or “retract.” If one of the partitions is in motion, the list of partitions may also indicate this movement to the user.

The continuity widget 210, when selected by the user of the HMI 30, provides electrical continuity information for the operable wall assembly 10. In order to properly extend and retract the operable wall assembly 10, and to provide the panels 22 with power for various devices, such as computer monitors, televisions, and electrical outlets, as well as lighting fixtures such as light-emitting diodes (“LEDs”), accent lighting, and other lighting fixtures, electrical continuity between panels 22 must be maintained. An example of a system continuity check is described in greater detail in U.S. Pat. No. 10,273,687, the contents of which are herein incorporated by reference. In general, if the panels 22 are not aligned correctly, power cannot be distributed properly to the panels 22, which can create hazards. Therefore, the system continuity check provides a small voltage, for example 5 volts, to the panels 22, and the electronic processor 105 receives a confirmation signal if the 5 volts properly pass through each of the panels 22. The confirmation signal indicates that it is safe to provide larger voltages, such as 65 volts alternating current or 120 volts direct current, to the panels 22 to power the various devices on the panels. The continuity widget 210 provides a status of the operable wall assembly 10 (e.g., “continuity” or “error”) and may also provide information about which panel of the panels 22 is not electrically continuous.

The glass widget 215, when selected by the user of the HMI 30, provides a list of partitions that include switchable glass. Switchable glass, or smart glass, is glass whose light transmission properties change when a voltage is applied to the glass. For example, if a voltage is applied, the glass may switch from transparent to translucent. In the glass widget 215, a status of each of the panels 22 that include switchable glass is shown (e.g., “transparent” vs “opaque”), and the user may also control the glass to switch states.

The faults widget 220, when selected by the user of the HMI 30, provides a list of faults for each partition. In some embodiments, the faults widget 220 also includes a notification that the operable wall assembly 10 has encountered a fault, such as detecting an object while moving. The notification may be provided as a visual, auditory, or haptic notification. The notification may indicate which partition has encountered a fault and what the fault is. In one embodiment, the notification may state “Partition 1 bhas detected an object by camera.”

The camera widget 225, when selected by the user of the HMI 30, provides a list of partitions that include a camera and, if a particular partition, such as the operable wall assembly 10, is selected, live camera video data is provided to the user via the GUI 200.

The devices widget 230, when selected by the user of the HMI 30, allows the user to control the various devices, such as computer monitors, televisions, and electrical outlets, as well as lighting fixtures such as LEDs, accent lighting, and other lighting fixtures, on the panels 22. For example, the LEDs may be switched on and off, accent lighting may be switched on and off, and LEDs in the top support assembly 20 or in the floor 12 may be controlled to change colors. Furthermore, if the panels 22 include glass, the LEDs may be controlled to change a color of any etching in the glass.

The help widget 235, when selected by the user of the HMI 30, provides a list of instructions if the user encounters errors while operating the control system 28. The about widget 240 provides information about the operable wall assembly 10 and the control system 28.

The administrator widget 245, when selected by the user of the HMI 30, allows the user to password protect the HMI 30 and add new partitions or devices to be controlled by the control system 28.

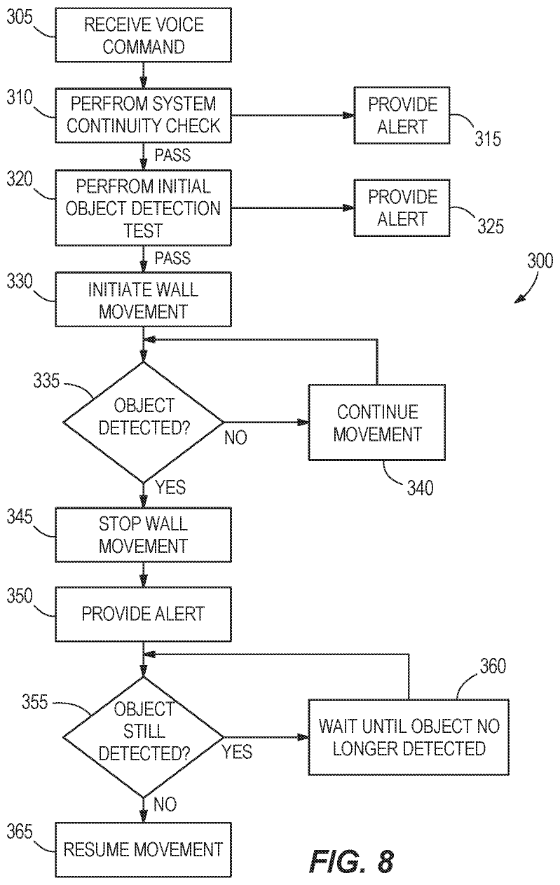

FIG. 8 illustrates a flow chart of a method 300 for controlling the operable wall assembly 10. The method 300 includes receiving, with the electronic processor 105, a voice command from the microphone 110 (block 305). The voice command is used to generate a command for the operable wall assembly 10. In some embodiments, the voice command is one of a plurality of predefined voice commands stored in a table in a memory. This plurality of predefined voice commands may include “extend wall,” “retract wall,” “switch glass,” “turn on lights,” and other commands.

The method 300 also includes performing, with the electronic processor 105, a system continuity check (block 310). The system continuity check includes checking to ensure electrical continuity between the panels 22 as described above. If an error occurs during the system continuity check, the electronic processor 105 generates an alert or notification of the error and provides it to the user of the HMI 30 (block 315), such as by applying a badge indicating a notification to the continuity widget 210 of the GUI 200.

After the system continuity check is performed, an initial object detection test is performed before beginning a wall movement (block 320). The initial object detection test is performed to ensure that no objects are immediately in the movement path of the operable wall assembly 10. If any of the plurality of sensors 130-133 detect an object, an alert is provided (block 325) by the electronic processor 105 to the user of the HMI 30, such as by applying a badge indicating a notification to the faults widget 220 of the GUI 200.

Once the initial object detection test is complete, the electronic processor 105 generates a command to the control box 120 to initiate the wall movement (block 330). The control box 120 then utilizes the prime mover 24 to move the panels 22 in response to the generated command.

While the panels 22 are moving, the plurality of sensors 130-133 monitor the surrounding area to detect objects (block 335). While no objects are detected, the panels 22 continue to move uninterrupted (block 340). If an object is detected by one or more of the plurality of sensors 130-133, the electronic processor 105 generates a command to the control box 120 indicating to stop the wall movement because an object was detected and the control box 120 controls the operable wall assembly 10 to stop the movement of the panels 22.

The object is detected based on the signals from the plurality of sensors 130-133. For example, a LIDAR sensor may detect a distance from the leading edge of the panels 22 to the second end support 18 and, if that distance abruptly changes (e.g., an object moves in between the leading edge and the second end support 18), may indicate that the. In another embodiment, a camera provides video data to the PLC 125, which generates a histogram of observed colors. If the histogram abruptly changes (e.g., new colors are suddenly detected), an object is determined to be detected. If a camera and histogram method is utilized, the electronic processor 105 may also send a command to activate lights on the panels 22, as detecting dark objects on dark backgrounds may be difficult. Activating lights on the panels 22 allows for better contrast of darker colors to be detected, as the area surrounding the panels 22 is better illuminated.

The electronic processor 105 then provides, via the faults widget 220 of the GUI 200, an alert or notification to the user that the wall movement has stopped (block 350). The alert or notification includes an identifier of the operable wall assembly 10 (e.g., “Partition 1”), a message indicating that the wall movement has stopped, and a reason why the wall movement has stopped. In some embodiments, in addition to indicating that the wall movement has stopped, the notification or alert may indicate which of the plurality of sensors 130-133 detected the object. In some embodiments, instead of providing the alert or notification via the GUI 200, the electronic processor 105 may generate an audio response and notify the user via an audio response from the HMI 30.

While the object is still detected (block 355), the panels 22 remain motionless and the electronic processor 105 waits for the object to no longer be detected (block 360). Once an object is no longer detected (e.g., a person moves away from the panels 22 or an object is moved out of the way), the electronic processor 105 generates a command to resume the movement of the panels 22.

Thus, embodiments described herein describe systems and methods for controlling an operable wall.

What is claimed is:

1. A system for controlling an operable wall configured to move between a deployed condition and a stacked condition, the system comprising:
a microphone,
a plurality of sensors, and
an electronic processor configured to
receive a voice command from a user via the microphone;
generate a command to initiate a wall movement of the operable wall based on the received voice command; and
in response to detecting an object with at least one sensor of the plurality of sensors,
generate a command to stop the wall movement;
provide an alert to the user that the wall movement has stopped; and
when the detected object is no longer detected by the at least one sensor,
generate a command to automatically resuming the wall movement.

2. The system of claim 1, the electronic processor further configured to perform a system continuity check before beginning the wall movement.

3. The system of claim 1, wherein the voice command received from the user is one of a plurality of predefined voice commands for initiating the wall movement.

4. The system of claim 1, wherein the plurality of sensors includes at least one sensor selected from the group of censors consisting of a LIDAR sensor, a camera, a lead bump detection sensor, an ultrasonic sensor, a PIR sensor, and a microwave sensor.

5. The system of claim 1, the electronic processor further configured to output a user interface to a display, and wherein the electronic processor is configured to provide the alert to user the via the user interface.

6. The system of claim 5, wherein the display is a display of a mobile device.

7. The system of claim 5, wherein the user interface illustrates the wall movement to the user and also indicates which sensor of the plurality of sensors has detected the detected object.

8. The system of claim 7, wherein the user interface includes a user input mechanism, and wherein when the user provides a first user input to the user input mechanism, the electronic processor is configured to display, on the user interface, at least one image from a camera of the plurality of sensors.

9. The system of claim 1, the electronic processor further configured to perform an initial object detection test before initiating the wall movement, and wherein the wall movement is not initiated if an object is detected.

10. The system of claim 1, wherein the operable wall includes a panel of switchable glass, and wherein the user can input a second voice command to switch an active state of the panel of switchable glass.

11. A method for controlling an operable wall configured to move between a deployed condition and a stacked condition, the method comprising
receiving, with an electronic processor, a voice command from a user via a microphone;
generating, with the electronic processor, a command to initiate a wall movement of the operable wall based on the received voice command; and
in response to detecting an object with at least one sensor of the plurality of sensors,
generating, with the electronic processor, a command to stop the wall movement;
providing, with the electronic processor, an alert to the user that the wall movement has stopped; and
when the detected object is no longer detected by the at least one sensor,
generating, with the electronic processor, a command to automatically resume the wall movement.

12. The method of claim 11, further comprising performing, with the electronic processor, a system continuity check before beginning the wall movement.

13. The method of claim 11, wherein the voice command received from the user is one of a plurality of predefined voice commands for initiating the wall movement.

14. The method of claim 11, wherein the plurality of sensors includes at least one sensor selected from the group of censors consisting of a LIDAR sensor, a camera, a lead bump detection sensor, an ultrasonic sensor, a PIR sensor, and a microwave sensor.

15. The method of claim 11, further comprising outputting, with the electronic processor, a user interface to a display, and providing, with the electronic processor, the alert to user the via the user interface.

16. The method of claim 15, wherein the display is a display of a mobile device.

17. The method of claim 15, wherein the user interface illustrates the wall movement to the user and also indicates which sensor of the plurality of sensors has detected the detected object.

18. The method of claim 17, further comprising receiving a first user input from the user at a first input mechanism of the user interface, and displaying, with the electronic processor, at least one image from a camera of the plurality of sensors on the user interface.

19. The method of claim 11, further comprising performing, with the electronic processor, an initial object detection test before initiating the wall movement, and wherein the wall movement is not initiated if an object is detected.

20. The method of claim 11, wherein the operable wall includes a panel of switchable glass, and wherein the user can input a second voice command to switch an active state of the panel of switchable glass.
